(19) United States
(12) Patent Application Publication
(10) Pub. No.: US 2004/0172845 A1
(43) Pub. Date: Sep. 9, 2004

(54) Rip guide tool

(76) Inventor: Joseph R. Eichhorn, West Chester, OH (US)

Correspondence Address: William M. Selenke, 5 Drummond St., Cincinnati, OH, 45218, US

(21) Appl. No.: 10/782,031

(22) Filed: Feb. 19, 2004

Related U.S. Application Data
(60) Provisional application No. 60/452,014, filed on Mar. 5, 2003.

(51) Int. Cl. B26D 7/06

(52) U.S. Cl. 33/640

(57) ABSTRACT

The invention is a guide for a power circular saw with a rail which rail has an attachment end and a spacer end. The attachment end has one or more bosses. Reversibly attached to the workpiece (saw) is a saw attachment piece which further comprises a blade part and an attachment part. That attachment part has one or more holes, which holes complementarily reversibly receive the bosses on the attachment end of the rail. The spacer is movable affixed as a ninety degree square to the rail at the position on the rail to provide the desired width of the saw cut. The spacer may have a T shape, an H shape or a square shape. The guide for a power circular saw of the present invention may have the saw attachment piece permanently attached to the circular hand saw. Likewise, the power circular saw guide of the present invention has a spacer which may be adjustably placed at angles on the rail other than ninety degrees, and may also be used a marking compass

### FIELD OF INVENTION

The present invention is concerned with saw guides for carpenters or other woodworkers to cut accurately across larger pieces of wood such as a four by eight foot piece of plywood. The saw guide is attached to or detached from the hand held circular saw with minimal difficulty, Secondly, indices for inches or centimeters are imprinted on the present invention. This lessens the need for a separate ruler. Additional features of the present invention are that it can be used as a 90° square, a “bevel square” (or protractor) as well as a marking compass.

### BACKGROUND OF INVENTION

Hand-held electric circular saws are common tools used by carpenters and other wood workers. They have been used for a number of decades and greatly increase the efficiency of carpenters. A common problem for carpenters using circular saws is to cut wider pieces of wood from such large stock as a standard four by eight foot piece of plywood. One method is either to use a straightedge or a caulk line to provide a line to guide the saw. In other instances a straightedge is attached with clamps to the plywood. The straightedge would provide a physical guide to provide an accurate cut through the plywood.

Cutting larger pieces from plywood or other large stock is a common problem. For this reason, there have been a number of patents that provide partial answers to this problem. An example is patent 4,483,071 issued to Te Kosté. Te Kosté provides a guide rail with indices to provide a means of placing the guide so that the saw blade is kept at the proper distance from the end. Likewise, 4,016,649 granted to Kostar provides a guide for a circular saw to cut larger pieces of plywood.

What is lacking in the currently available products both patented and not patented is a guide that is accurate and easily removed. A busy carpenter needs to remove the guide, set it side, and cut cross cut without spending much time attaching or removing the guide. The present invention provides a simple yet accurate guide that may be easily and quickly attached to or detached from circular saw. Likewise, it has the advantage that it is readily available to be used as a large protractor (bevel level) or compass, as well as 90° square.

### SUMMERY OF INVENTION

The invention is a guide for a power circular saw with a rail, that rail has an attachment end and a spacer end. The attachment end has one or more bosses. Reversibly attached to the workpiece (saw) is a saw attachment piece which further comprises a blade part and an attachment part. That attachment part has one or more holes, which holes complementarily reversibly receive the bosses on the attachment end of the rail and a spacer is movable affixed as a ninety degree square to the rail at the position on the rail to provide the desired width of the saw cut. The spacer may have a T shape, an H shape or a square shape. The guide for a power circular saw of the present invention may have the saw attachment piece permanently attached to the circular hand saw. This invention is a guide for a power circular saw with a rail; which rail has an attachment end and a spacer end; and a means of readily reversibly affixing the rail to the saw and a spacer which is movable affixed as a ninety degree square to said rail. Likewise, the power circular saw guide of the present has a spacer which may be adjustably placed at angles on the rail other than ninety degree.

### BRIEF DESCRIPTION OF THE FIGURES

FIG. 1 is the overview of one embodiment of the rip guide tool.

FIG. 2 shows a two boss and two holes means of the attachment the rail with the secondary means of attachment. An alternative single boss and hole system is shown as FIG. 3.

FIG. 4 shows the top view of the saw guide ready for use.

FIG. 5 show a board edge view of the guide attached to the saw.

FIG. 6 shows the guide in use as a 90° square.

FIG. 7 show the used of the guide of the present invention as a bevel square.

FIG. 8 illustrated the guide as a compass.

FIG. 9 shows that guide of the present invention may be attached to a second kind of connector that may be permanently or temporarily placed on the saw

### DETAILED DESCRIPTION OF THE FIGURES

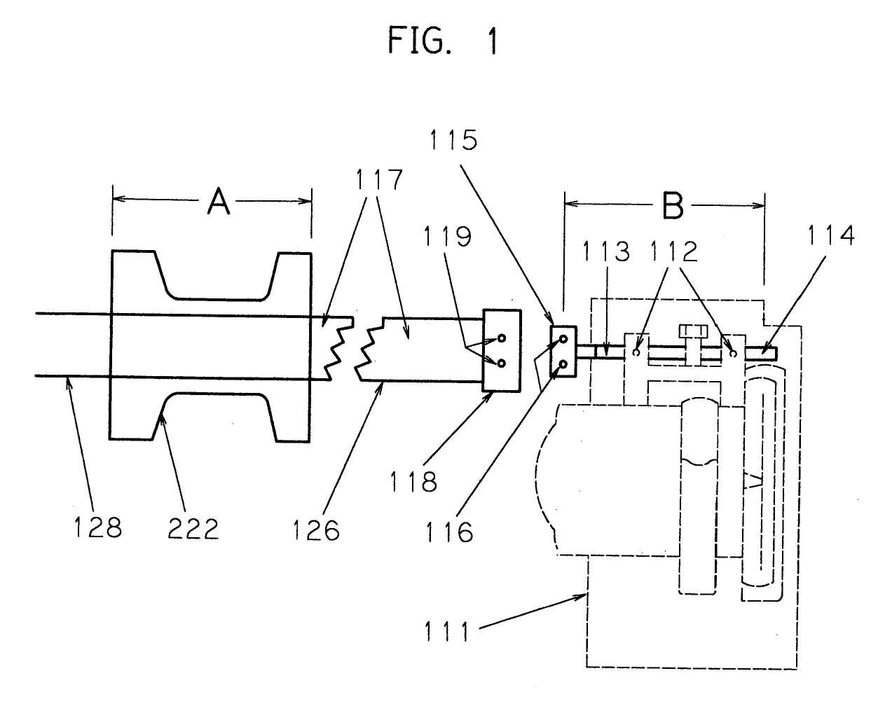

FIG. 1 is an illustration of one embodiment of the rip guide tool. The power saw which is the work piece is shown in an outline as 111. Most commercial saws have a receiving area for a flat blade guide with an end with a 90° bend Typically, this guide is held in place by screws 112. Instead of the commercial flat blade used as a guide (which is usually an included accessory with the purchased circular saw), the present invention provides a secondary means of attachment 113. The secondary means of attachment 113 consist of a blade part 114 and an attachment part 115. Attachment part 115 has a pair (one or more) of holes 116 to receive the rail 117. Rail 117 has a spacer end 128 and an attachment end 118. Attachment end 118 has two bosses 119 which bosses 119 are placed in holes 116 to attach rail 117 to attachment part 115. Bosses 119 have a complimentary fit with holes 116. Attached distal to attachment 118 is a spacer 222. Spacer 222 in this embodiment is shaped as an H. (Other embodiments have a T shaped or rectangular spacer.) It is to be noted that optimally width A of the spacer is the same as the distance B from the edge of the blade of the saw to holes 116. (Both length A and length B are commonly 6 inches.)

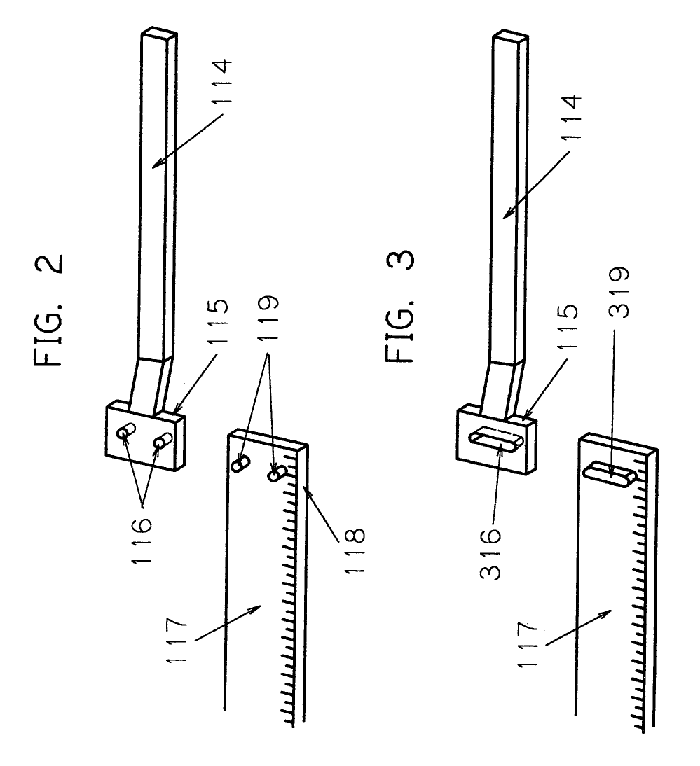

FIG. 2 shows the attachment the rail 117 with blade part 114. The attachment means is one or more depressions or holes 116 with complementary bosses 119. The means of attachment for the rail 117 consist of a blade part 114 and an attachment part 115. Attachment part 115 has a pair of holes 116 to receive the rail 117. Attachment end 118 has two bosses 119 which bosses (pins) 119 are placed in holes 116 to reversible attach rail 117 to attachment part 115. One of the bosses 119 may be longer than the other. An alternative boss and hole system is shown as FIG. 3.

FIG. 3 shows the blade part 114 and an attachment part 115. Attachment part 115 has a pill shaped hole 316. Pill shaped boss 319 complementarily fits into pill shaped hole 316 which is in attachment end 115. Of course, other shapes of bosses and respective complementary holes could be used. While FIGS. 2 and 3 show the boss(es) 119 and 319 on the rail 117 and the holes 116 and 316 on the attachment part; in fact, the holes could be on the rail and the boss(es) on the attachment part.

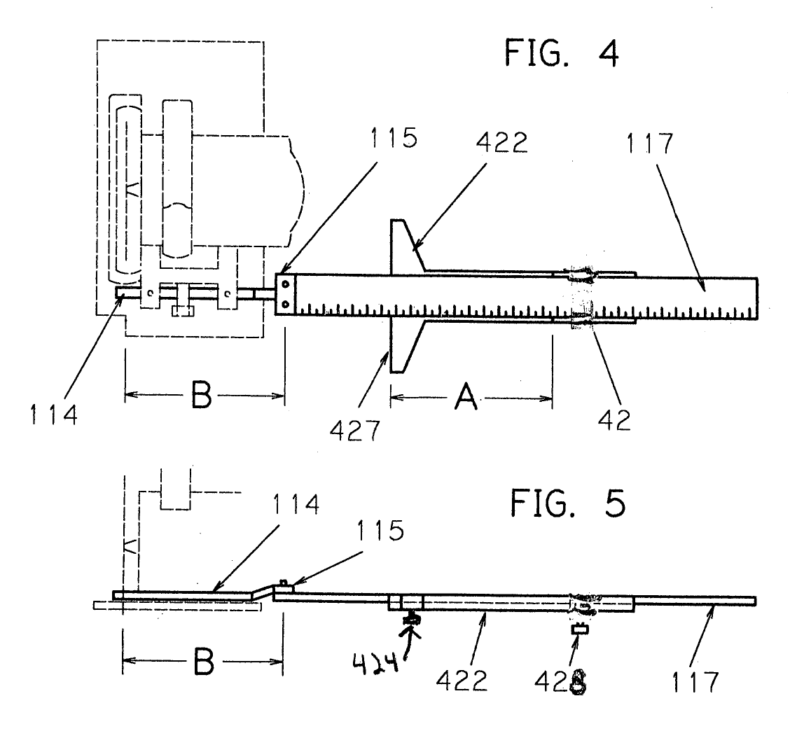

FIG. 4 shows the top view of the saw guide ready for use. The rail 117 is attached to attachment end 115 of the blade part 114. It is to be noted that spacer 422 has the same function as spacer 222, but spacer 422 and spacer 222 are of different shapes. The spacers may be of different shapes. Likewise shown is pivot point blot 424. Pivot point 424 attaches spacer 422 to rail 117 to create a 90° square. Pivot point 424 can be used to change the angle of the space edge 427 to make bevel square. A lock screw 428 provides an additional affixing means for the spacer and rail.

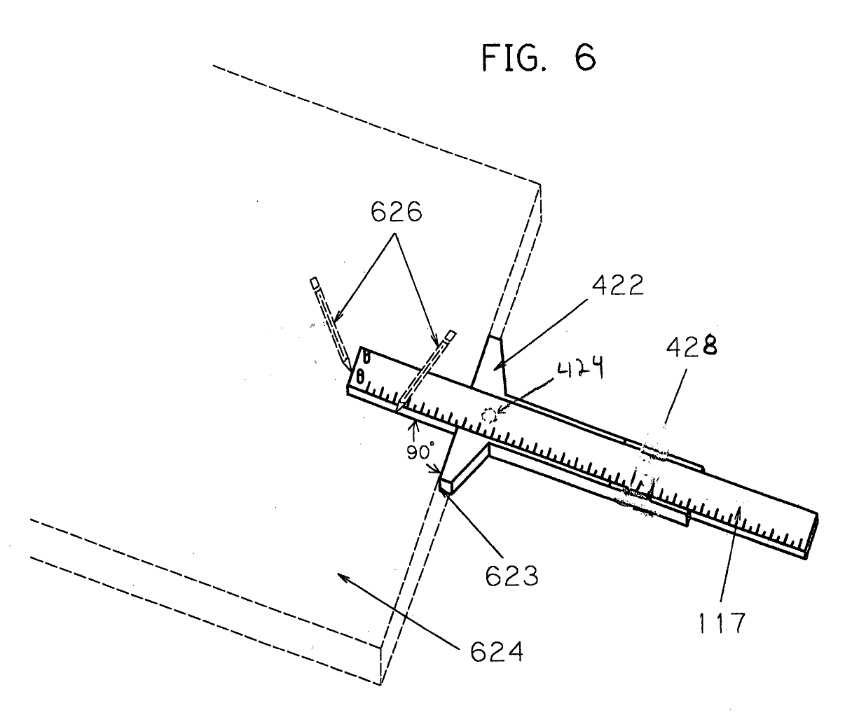

FIG. 5 show a board edge view of the guide attached to the saw. The rail 117 is attached to the blade part 114 attachment end 115. Pivot point 424 attaches spacer 422 to rail 117.

FIG. 6 shows the guide in use as a 90° square. Pivot point 424 attaches spacer 422 to rail 117 at a 90° angle. Spacer edge 623 is placed snug to the wood (workpiece) 624 shown in outline. Rail 117 then is used as a straightedge to provide a 90° angle with the edges of workpiece 624. Pencil 626 a workpiece then can mark the line to be cut later. FIG. 6 illustrates the use of the guide of the present invention as a 90° square.

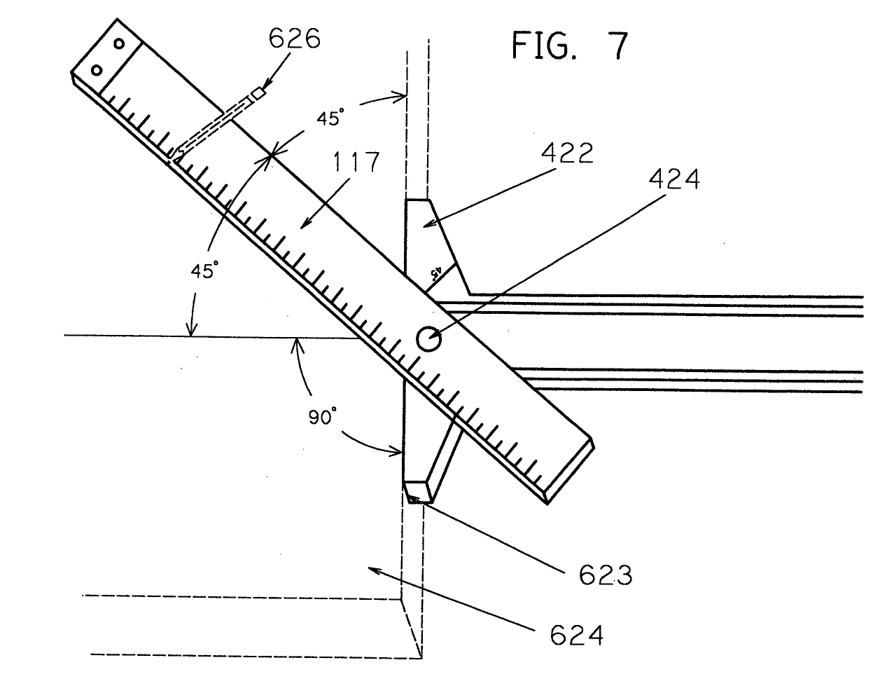

FIG. 7 shows the guide in use as a bevel square. Pivot point 424 attaches spacer 422 to rail 117 at a non-90° angle (illustrated as a 45° angle). Spacer edge 623 is placed snug to the wood (workpiece) 624 shown in outline. Rail 117 then is used as a straightedge to provide a non-90° angle with the edges of workpiece 624. Pencil 626, a workpiece, then can mark the line to be cut later. FIG. 7 illustrates the used of the guide of the present invention as a bevel square.

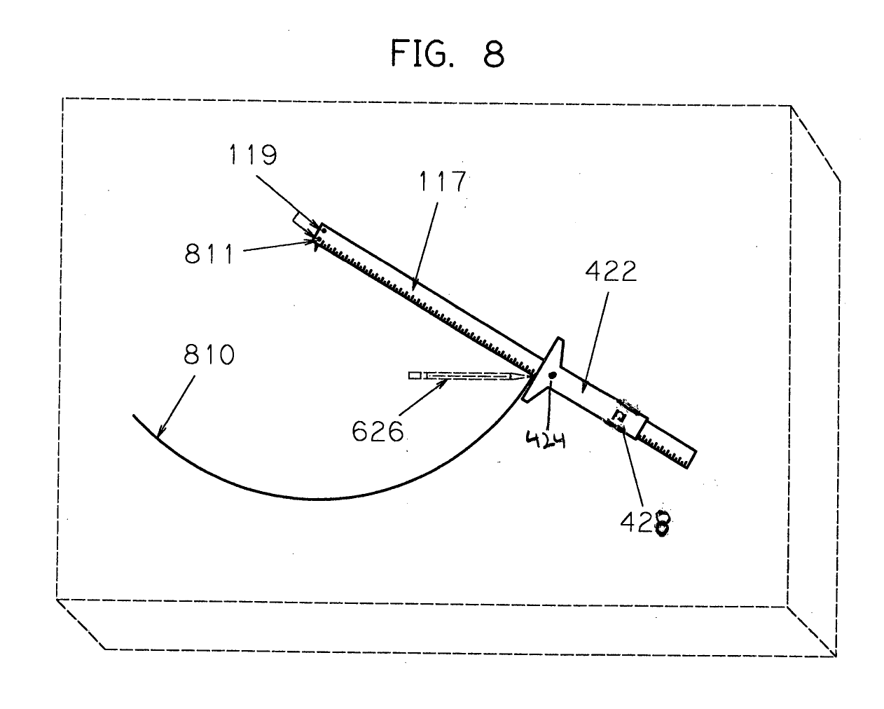

FIG. 8 illustrated the guide as a compass. The longer of the two pins (119) may be used as a central point 811 of the radius of the compass. This nail or other means may secure the center of the radius 810. The rail 117 provides the radius distance 810 from attachment end 115. Pivot point 424 adjustably affixes spacer 422 to rail 117.

A workpiece pencil 626 (shown in outline) is placed in the corner between rail 117 and spacer 422. The rail 117 with spacer 422 makes a circle around the central point 811 of the circle. The pencil 626 will trace an outline of a circle to be later cut with a saber saw or other such saws capable of cutting a non-straight line. Of course, other means such as a round hole for pencil 626 may be provided on spacer 422.

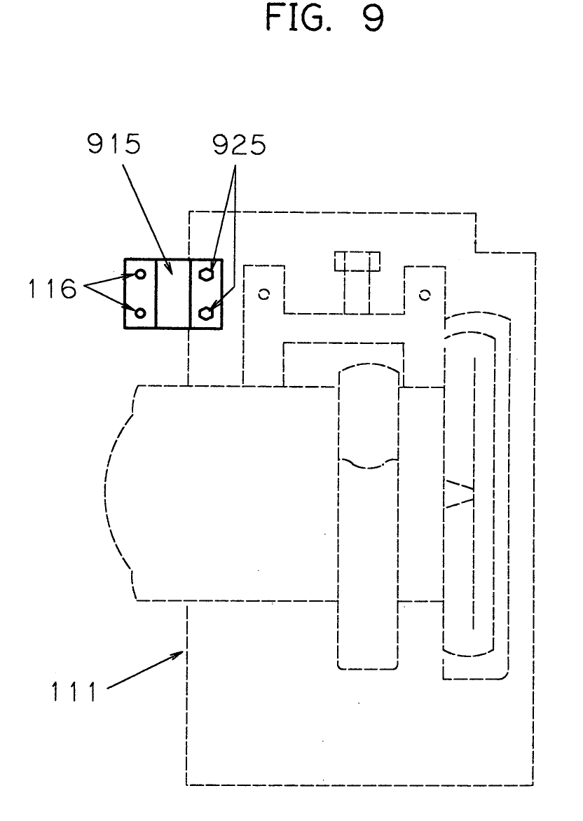

FIG. 9 shows that the attachment 915 may be placed on the workpiece saw 111. Attachment 915, which may be permanently or reversible attached to saw 111. provides holes 116 to reversible attach rail 117 by means of bosses 119. As part of the manufacturing process for the base of the saw optionally boss(es) may be places either on the saw or rail and the complementary holes on the respective rail or saw.

We claim:

1) A guide for a power circular saw comprising:
a rail;
said rail has an attachment end and a spacer end;
said attachment end has one or more bosses;
reversibly attached to the workpiece is a saw attachment piece which further comprises a
blade part and an attachment part;
said attachment part has one or more holes;
said holes complementarily reversibly receive said bosses on said attachment end;
a spacer is movable affixed as a ninety degree square to said rail;
said spacer is moveably affixed at the position on said rail to provide the desired width of the saw cut.

2) A guide for a power circular saw as in claim one wherein said spacer has a T shape.

3) A guide for a power circular saw as in claim one wherein said spacer an H shape.

4) A guide for a power circular saw as in claim one wherein said saw attachment piece is permanently attached to the circular hand saw.

5) A guide for a power circular saw comprising:
a rail;
said rail has an attachment end and a spacer end;
means of readily reversibly affixing said rail to the saw;
a spacer is movable affixed as a ninety degree square to said rail;.

6) A guide for a power circular saw as in claim one wherein said spacer may be adjustably placed at angles other than ninety degree.
